(19) United States
(12) Patent Application Publication
(10) Pub. No.: US 2023/0406276 A1
(43) Pub. Date: Dec. 21, 2023

(54) Comfort Brake Control System and Control Method for Vehicle

(71) Applicant: Robert Bosch GmbH, Stuttgart (DE)

(72) Inventors: Ying Zhang, Suzhou (CN); Chongxi Huang, Suzhou (CN); Renrui Wang, Suzhou (CN)

(21) Appl. No.: 18/332,505

(22) Filed: Jun. 9, 2023

(30) Foreign Application Priority Data
Jun. 17, 2022 (CN) 2022 1069 1857.7

(51) Int. Cl. B60T 8/58; B60T 8/172

(52) U.S. Cl. CPC B60T 8/58; B60T 8/172; B60T 2230/04; B60T 2250/00; B60T 2270/88; B60T 2250/04

(57) ABSTRACT

A comfort brake control system and control method for a vehicle are disclosed. The vehicle has multiple optional comfort brake levels, and each comfort brake level includes one or more brake parameters corresponding to the comfort brake level. The comfort brake control system includes: a human-machine interaction interface, configured to provide an interface for modifying the one or more brake parameters and receive a modification to at least one of the one or more brake parameters; and a comfort brake module, configured to determine whether the modification satisfies a safety requirement, allow the modification when it is determined that the modification satisfies the safety requirement, and prohibit the modification when it is determined that the modification does not satisfy the safety requirement; wherein the comfort brake module is further configured to assess a comfort degree of vehicle braking after the modification if it is determined that the modification satisfies the safety requirement.

This application claims priority under 35 U.S.C. § 119 to application no. CN 2022 1069 1857.7, filed on Jun. 17, 2022 in China, the disclosure of which is incorporated herein by reference in its entirety.

This application relates to the field of vehicle braking technologies, and in particular, to a comfort brake control system and a comfort brake control method for a vehicle.

### BACKGROUND

Recently, research on self-driving technologies has been very active. User experience of a self-driving vehicle directly affects user acceptance and trust in the self-driving vehicle, and further affects popularization of the self-driving vehicle. Therefore, solutions to improve the user experience of the self-driving vehicle need to be explored.

In the prior art, improving the user experience during vehicle braking is a challenge because too much attention to the user experience can create potential safety hazards, while ignoring the user experience can greatly reduce user satisfaction with self-driving vehicles. In addition, user experience may vary from person to person and may be described as “difficult to cater for all tastes”. Based on existing vehicle braking strategies, it is difficult to satisfy user experience that is both differential and personalized.

### SUMMARY

In this context, the present disclosure is intended to provide a comfort brake control scheme for a vehicle, which can provide an interface for a user to adjust a brake parameter, and be able to detect whether the adjustment satisfies safety and assess a comfort degree of vehicle braking after the adjustment, thereby achieving comfort brake that “caters for all tastes”.

According to one aspect of the present disclosure, there is provided a comfort brake control system for a vehicle having multiple optional comfort brake levels, each comfort brake level comprising one or more brake parameters corresponding to the comfort brake level, the comfort brake control system comprising: a human-machine interaction interface, configured to provide an interface for modifying the one or more brake parameters and receive a modification to at least one of the one or more brake parameters; and a comfort brake module, configured to determine whether the modification satisfies a safety requirement, allow the modification when it is determined that the modification satisfies the safety requirement, and prohibit the modification when it is determined that the modification does not satisfy the safety requirement; wherein the comfort brake module is further configured to assess a comfort degree of vehicle braking after the modification if it is determined that the modification satisfies the safety requirement.

According to another aspect of the present disclosure, there is provided a comfort brake control method for a vehicle, optionally performed by the foregoing comfort brake control system, wherein the vehicle has multiple optional comfort brake levels, each comfort brake level comprises one or more brake parameters corresponding to the comfort brake level, and the method comprises: providing an interface for modifying the one or more brake parameters; receiving a modification to at least one of the one or more brake parameters; determining whether the modification satisfies the safety requirement; allowing the modification when it is determined that the modification satisfies the safety requirement; and prohibiting the modification when it is determined that the modification does not satisfy the safety requirement; and the method further comprises: assessing a comfort degree of vehicle braking after the modification if it is determined that the modification satisfies the safety requirement.

The above gives an overview of the main aspects of the present disclosure in order to allow for a basic understanding of these aspects. This overview is not intended to define the scope of any or all aspects of the present disclosure. The purpose of this overview is to provide some implementations of these aspects in a simplified form as a preamble to the detailed description given later.

### BRIEF DESCRIPTION OF THE DRAWINGS

The technical solutions of the present disclosure are clearer from the following detailed description with reference to the accompanying drawings. It may be understood that these accompanying drawings are merely used for illustration purposes, but are not intended to limit the protection scope of the present disclosure.

FIG. 1 is a schematic diagram of a comfort brake control system for a vehicle according to an embodiment of the present disclosure.

FIG. 2 is a schematic diagram of a comfort brake level according to an embodiment of the present disclosure.

FIG. 3 is a flowchart of a comfort brake control process according to an embodiment of the present disclosure.

FIG. 4 is a flowchart of a comfort brake control process according to another embodiment of the present disclosure.

FIG. 5 is an example of a curve graph used in the comfort brake control process in FIG. 4.

FIG. 6 is a flowchart of a comfort brake control process according to still another embodiment of the present disclosure.

FIG. 7 is an example of a curve graph used in the comfort brake control process in FIG. 6.

FIG. 8 is a flowchart of a comfort brake control process according to yet another embodiment of the present disclosure.

FIG. 9 is an example of a curve graph used in the comfort brake control process in FIG. 8.

FIG. 10 is a flowchart of a comfort brake control process according to yet another embodiment of the present disclosure.

FIG. 11 is a flowchart of a comfort brake control method according to an embodiment of the present disclosure.

### DETAILED DESCRIPTION

Embodiments of the present disclosure are directed to a control strategy for vehicle comfort brake that is capable of allowing a user to modify a brake parameter to change a braking process and is capable of assessing a comfort degree of vehicle braking after the user adjusts the brake parameter from multiple dimensions.

According to an embodiment of the present disclosure, it is able to embody the follow-up of subjective feelings of the user, and it is able to calculate behavior characteristics of the vehicle during the braking process of the vehicle by virtue of algorithm logic, thereby realizing a comfort brake function that integrates user experience.

The following describes specific implementations of the present disclosure with reference to the accompanying drawings.

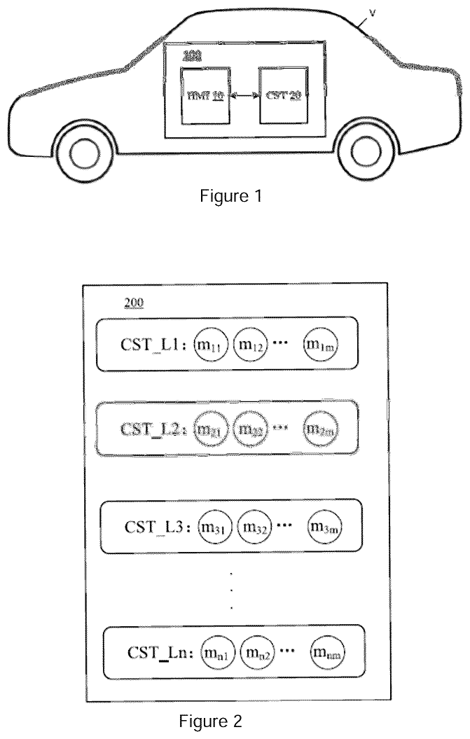

FIG. 1 schematically shows a comfort brake control system 100 for a vehicle V according to an embodiment of the present disclosure. The comfort brake control system 100 is disposed on the vehicle V. Therefore, the comfort brake control system 100 may also be referred to as an in-vehicle system. As shown in FIG. 1, the comfort brake control system 100 includes a human-machine interaction interface (HMI) 10 and a comfort brake module (CST) 20.

The human-machine interaction interface 10 is communicatively connected to the comfort brake module 20, and is configured to implement information exchange between the vehicle V and an in-vehicle infotainment system by a user. The human-machine interaction interface 10 may receive user input, and transmit the user input to the comfort brake module 20. The human-machine interaction interface 10 may further provide the user with information related to vehicle comfort brake. For example, a graphical user interface for the user to modify the brake parameter is presented to the user or voice associated with comfort brake is broadcast to the user.

The human-machine interaction interface 10 may implement information exchange between the user in the vehicle and the in-vehicle infotainment system by using multiple human-machine interaction manners, for example, one or more of a touchscreen, voice, action recognition (for example, gesture recognition), and a physical button.

In an embodiment, the human-machine interaction interface 10 includes one or more of: a central control screen of the vehicle V (for example, the user expresses, by touching the central control screen, a vehicle brake requirement of the user), a voice control system (for example, the user expresses, via voice, a vehicle brake requirement of the user), a gesture recognition system (for example, the user expresses, by using a predefined gesture, a vehicle brake requirement of the user), and a button or a knob disposed at a position convenient for the user in the vehicle to operate (for example, the user expresses, by operating the button or the knob, a vehicle brake requirement of the user).

The comfort brake module 20 implements the comfort brake function based on information from the human-machine interface 10 and information from one or more in-vehicle sensors (not shown), for example, determining whether the user-modified brake parameter satisfies the safety requirement and assessing the comfort degree of the vehicle after the user modified the brake parameter.

The comfort brake module 20 may be disposed in a control unit of a self-driving system of the vehicle V, or may be disposed in a domain controller of the vehicle V, or may be disposed in a control unit of a brake system of the vehicle V.

Multiple comfort brake levels are stored in the comfort brake module 20. The multiple comfort brake levels are predetermined and respectively correspond to different comfort levels in the braking process of the vehicle V. For example, the multiple comfort brake levels may include a high comfort brake level, an medium comfort brake level, and a low comfort brake level. The high comfort brake level indicates highest (for example, smoothest) comfort during braking. The medium comfort brake level indicates medium comfort during braking (e.g. medium smooth). The low comfort brake level indicates moderate comfort during braking (for example, slight shaking during braking).

In an embodiment, a quantity of comfort brake levels is predetermined, e.g., it is predetermined that there are six comfort brake levels. The quantity of comfort brake levels can be adjusted to more or less depending on user requirements before a new vehicle is delivered from factory or after the vehicle has been factory reset.

Each comfort brake level contains a brake parameter that corresponds to the comfort brake level. For example, the high comfort brake level includes a brake parameter corresponding to the high comfort brake level. The medium comfort brake level includes a brake parameter corresponding to the medium comfort brake. In addition, the low comfort brake level includes a brake parameter corresponding to the low comfort brake level.

The brake parameter includes one or more brake parameters directly or indirectly related to vehicle braking. The brake parameter may include brake pressure of at least one braking cylinder and a brake pressure change rate of the vehicle V. The brake pressure may be brake pressure of any one of multiple brake cylinders of the vehicle V, or may be a sum or an average value of brake pressures of the multiple brake cylinders. The brake parameter may further include a speed of the vehicle V during braking and an acceleration of the vehicle V during braking.

Each brake parameter may be a variable throughout the braking process, for example, the brake parameter may be expressed as a curve that varies with time during the braking process. The change range of the brake parameter at each comfort brake level is predetermined and is stored in the comfort brake module 20. For example, the brake pressure has a first change range at a high comfort brake level, a second change range at a medium comfort brake level, and a third change range at a low comfort brake level. The first to third change ranges are stored in the comfort brake module 20.

FIG. 2 schematically shows a comfort brake level according to an embodiment of the present disclosure. Referring to FIG. 2. the vehicle V has multiple optional comfort brake levels CST_L1, CST_L2, CST_L3, . . . CST_Ln. Each comfort brake level includes a brake parameter corresponding to the level, that is, the comfort brake level CST_L1 includes corresponding brake parameters m₁₁, m₁₂, m₁₃, . . . m₁ₘ. The comfort brake level CST_L2 includes corresponding brake parameters m₂₁, m₂₂, m₂₃, . . . m₂ₘ, and the comfort brake level CST_Ln includes corresponding brake parameters mₙ₁, mₙ₂, mₙ₃, . . . mₙₘ.

In an embodiment, the human-machine interaction interface 10 is implemented as a touchscreen. A graphical user interface 200 including multiple comfort brake levels and corresponding brake parameters is presented on the touchscreen. The graphical user interface 200 includes multiple button icons, each button icon corresponding to one brake parameter. For example, referring to FIG. 2, each of brake parameters m₁₂, m₁₃, . . . , and m₁ₘ of a comfort brake level CST_L1 is presented on the touchscreen as one button icon. These button icons are capable of receiving user inputs, i.e., a user can select the brake parameter corresponding to the button by clicking the button icon and enter an interface (not shown) to modify the brake parameter. The human-machine interaction interface 10 receives user input, and transmits the received user input to the comfort brake module 20.

In another embodiment, the human-machine interaction interface 10 is implemented as a voice interaction interface that may receive voice input from the user for the user to modify the brake parameter. For example, the user expresses modifying of the brake parameter by speaking: “increase the brake pressure” or “shorten the brake duration”. The human-machine interaction interface 10 receives the voice input, and transmits the user input to the comfort brake module 20.

The comfort brake module 20 may be implemented by using hardware, software, or a combination of software and hardware. Parts implemented by hardware may be implemented in one or more application-specific integrated circuits (ASIC), digital signal processors (DSP), data signal processing devices (DSPD), programmable logic devices (PLD), field programmable gate arrays (FPGA), processors, controllers, microcontrollers, microprocessors, electronic units designed to perform functions thereof, or combinations thereof. Parts implemented by software may be implemented by using microcode, program code, or a code segment, or may be stored in a machine-readable storage medium such as a storage component.

In an embodiment, the comfort brake module 20 includes a memory and a processor. The memory includes instructions, and when the instructions are executed by the processor, the processor performs the comfort brake control policy/comfort brake control method according to this embodiment of the present disclosure.

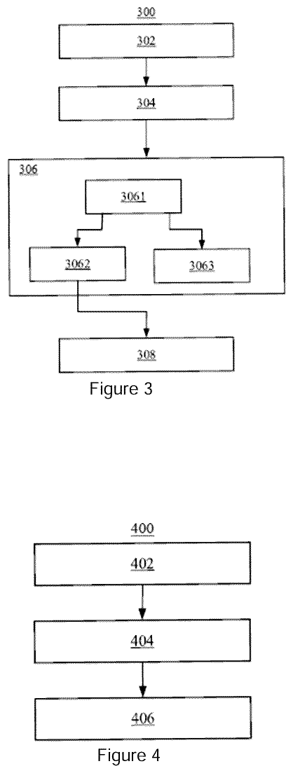

FIG. 3 shows a comfort brake control process 300 according to an embodiment of the present disclosure. According to the process 300, the user may modify the brake parameter according to specific needs or preferences, then the comfort brake module 20 determines whether the modification satisfies the safety requirement, and then assesses the comfort degree of vehicle braking after the modification if it is determined that the modification satisfies the safety requirement.

Referring to FIG. 3, in block 302, the human-machine interaction interface 10 provides an interface for the user to modify one or more brake parameters.

The interface may be a graphical user interface (for example, the graphical user interface 200 shown in FIG. 2). For example, the graphical user interface is presented on the touchscreen and includes a button icon that may receive a brake parameter from a user input. On the graphical user interface 200, the user may select a button icon for a brake parameter by clicking the button icon. The interface may also be a voice interaction interface, for example, the voice interaction interface broadcasts voice: “Please select a brake parameter to be adjusted”.

In block 304, the human-machine interaction interface 10 receives user modification to at least one brake parameter.

Corresponding to the above implementation of the human-machine interaction interface 10, if the human-machine interaction interface 10 is implemented as a touchscreen, in response to the user selecting a button icon of a brake parameter, a text box to modify the brake parameter is presented on the touchscreen in the form of a small window or a lower interface, and the user may enter an expected value for the brake parameter in the text box, i.e. adjust the brake parameter from the current value to the expected value. Where the human-machine interaction interface 10 is implemented as a voice interaction interface, the user speaks: “increase the brake pressure by 10%” or “decrease the brake duration to 1s”.

In block 306, the comfort brake module 20 determines whether the modification made by the user satisfies the safety requirement.

In an embodiment, the comfort brake module 20 determines whether the modification made by the user satisfies the safety requirement in the following manner: In block 3061, the comfort brake module 20 determines whether the modified at least one brake parameter is within a predetermined change range of the current comfort brake level. This change range is pre-stored in the comfort brake module 20. For example, if the current comfort brake level is medium, and the user-modified brake parameter is brake pressure, the comfort brake module 20 determines whether the user-modified brake pressure is still within the change range of the brake pressure at the medium comfort brake level. If the modified brake parameter is determined to be within the change range at the current comfort brake level, block 3062 is entered. In block 3062, the comfort brake module 20 determines that the modification satisfies the safety requirement. If the modified brake parameter is determined not to be within the change range at the current comfort brake level, block 3063 is entered. In block 3063, the comfort brake module 20 determines that the modification does not satisfy the safety requirement.

If it is determined that the modification does not satisfy the safety requirement, the comfort brake module 20 prohibits the modification, and the human-machine interaction interface 10 provides information to the user in the form of a graphical user interface or voice broadcasting that the modification does not satisfy the safety requirement. When it is determined that the modification satisfies the safety requirement, the process 300 continues.

Next, in block 308, the comfort brake module 20 assesses the comfort degree of vehicle braking after the modification if the modification satisfies the safety requirement. The assessment of the comfort degree may include one or more of: assessment of the comfort degree during the period from braking of the vehicle to the complete stop of the vehicle, assessment of the comfort degree during the period from the start of vehicle braking to the speed of the vehicle becoming a low speed, and the user's rating of experience of the vehicle's braking process based on his/her own experience.

It will be understood that the user's modification of the brake parameter may include modification to one or more brake parameters. With the user modifying multiple brake parameters, in determining safety, the comfort brake module 20 makes the above-mentioned safety determining separately for the modification to each brake parameter. Moreover, in assessing the comfort degree, the comfort brake module 20 assesses the modification to multiple brake parameters as a whole, rather than separately assessing the modification to each brake parameter.

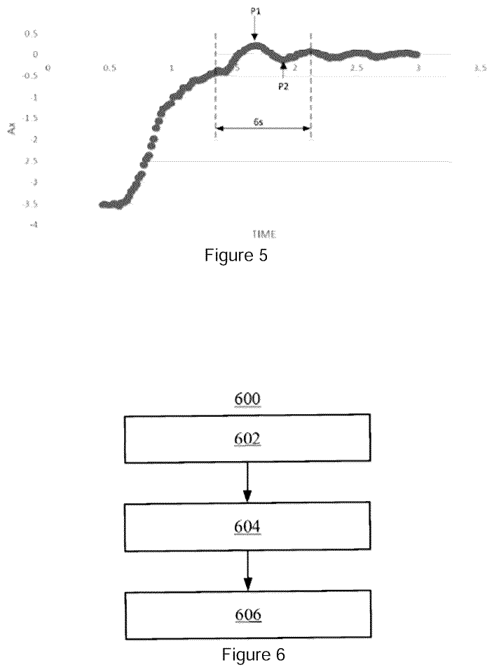

FIG. 4 shows a comfort brake control process 400 according to another embodiment of the present disclosure. According to the process 400, the comfort brake module 20 assesses the brake comfort degree based on the change in the comfort parameter during the period from vehicle braking to the vehicle being fully stopped. The comfort parameter refers to a parameter capable of characterizing the comfort of vehicle braking. For example, the comfort parameter includes one or more of: a longitudinal acceleration of a vehicle V, a pitch angle of the vehicle V, and a displacement amount of a suspension of the vehicle V. FIG. 5 is an example of a curve graph used in the process 400. In FIG. 5, the horizontal coordinate is time. The vertical coordinate is the longitudinal acceleration of the vehicle. The curve represents the change of the longitudinal acceleration of the vehicle over time during vehicle braking.

The following describes the process 400 with reference to FIG. 4 and FIG. 5.

In block 402, the comfort brake module 20 obtains the comfort parameter during the brake period. The comfort parameter may be measured by one or more in-vehicle sensors and transmitted from the one or more in-vehicle sensors to the comfort brake module 20. In an embodiment, the comfort parameter is the longitudinal acceleration of the vehicle V, see the curve in FIG. 5.

The brake period refers to the period from vehicle braking to full stop. For example, during the comfort braking of the vehicle, the brake period refers to the period from the vehicle speed dropping to zero or the vehicle speed approaching zero until the vehicle is fully stopped. The vehicle speed approaching zero may be set up in advance according to the specific application scenario or user needs, and may be adjustable.

In an embodiment, the comfort brake module 20 may determine the brake period in this manner: The longitudinal speed of the vehicle V is monitored, and the period of time for which the longitudinal speed of the vehicle is zero for predetermined duration is used as the brake period. In the brake period, i.e., the vehicle speed of the vehicle V has fallen to zero for the predetermined duration, but the vehicle V will experience transient shaking that can manifest itself in the change in the comfort parameter, for example, change in the longitudinal acceleration of the vehicle, change in the pitch angle of the vehicle, and change in the displacement amount of the vehicle suspension. Referring to FIG. 5, the predetermined duration is a defined period of time for the two dashed lines (i.e., predetermined duration of 6s). This predetermined duration is obtained according to an actual vehicle test result and/or model calculation and is stored in the comfort brake module 20 in advance.

In block 404, the comfort brake module 20 calculates an absolute value of a difference between a peak value and a valley value of the obtained comfort parameter in the brake period. For example, see FIG. 5, the peak value in the brake period is P1, the valley value is P2, and the comfort brake module 20 calculates the absolute value of the difference between the peak value P1 and the valley value P2.

In block 406, the comfort brake module 20 assesses the comfort degree based on the absolute value of the difference calculated in block 404 to obtain a first assessment result (i.e., an assessment result associated with the comfort parameter). The first assessment result includes: The smaller the absolute value of the difference, the higher the comfort degree; the greater the absolute value of the difference, the lower the comfort degree.

In block 406, the assessment result of the comfort degree may be expressed in a variety of ways. Two examples representing the assessment result are presented below.

In an embodiment, the comfort brake module 20 determines if the absolute value of the difference is less than a first comfort threshold (i.e., the comfort threshold associated with the comfort parameter). When the absolute value of the difference is determined to be less than the first comfort threshold, the first assessment result is that the comfort is satisfactory. When the absolute value of the difference is determined to be not less than the comfort threshold, the first assessment result is that the comfort is not satisfactory. In this embodiment, the first assessment result includes two levels of satisfactory comfort and unsatisfactory comfort.

In another embodiment, the comfort brake module 20 expresses the first assessment result with a score, e.g., a score of 0-100 points for the comfort degree, where 100 points indicate the assessment is the highest comfort degree (e.g., the absolute value of the difference is less than the first comfort threshold), and 0 points indicate the assessment is the lowest comfort degree (e.g., the absolute value of the difference is greater than or equal to twice the first comfort threshold). In this embodiment, the comfort brake module 20 may employ an algorithmic model or a machine learning model to give a score of the comfort degree.

It will be understood that the first comfort threshold is obtained based on an actual vehicle test result and/or model calculation and is stored in the comfort brake module 20 in advance.

Additionally, the comfort brake module 20 may obtain one or more comfort parameters and assess the comfort degree based on the one or more comfort parameters. With multiple comfort parameters obtained, the comfort brake module 20 may assess the comfort degree for each comfort parameter according to the above-described process 400 and then obtain a calculated average or weighted average of these comfort levels as a final assessment result of the comfort degree.

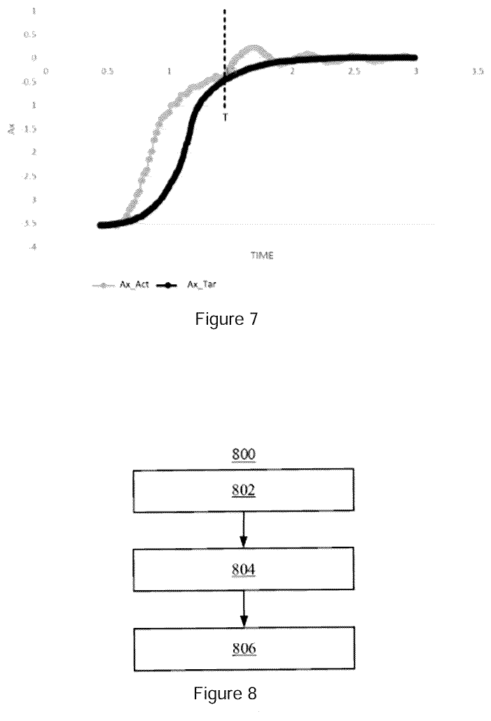

FIG. 6 shows a comfort brake control process 600 according to still another embodiment of the present disclosure. According to the process 600, the comfort brake module 20 assesses the comfort degree after adjusting the brake parameter based on the difference in acceleration between the actual longitudinal acceleration (hereinafter referred to as “actual acceleration”) and the expected longitudinal acceleration (hereinafter referred to as “expected acceleration”) of the vehicle V. FIG. 7 is an example of a curve graph used in the process 600. In FIG. 7, the horizontal coordinate represents the time of the braking process. The vertical coordinate is the longitudinal acceleration of the vehicle. The black curve represents the expected acceleration (Ax_Tar) of the vehicle in the braking process. A curve of light gray indicates the actual acceleration (Ax_Act) of the vehicle during the braking process. The expected acceleration may be obtained in advance by using a real vehicle test result and/or through model calculation. As shown in FIG. 7, the expected acceleration is expressed, e.g., as a curve of the expected acceleration changing over time, and is pre-stored in the comfort brake module 20.

The following describes the process 600 with reference to FIG. 6 and FIG. 7.

In block 602, the comfort brake module 20 obtains the actual acceleration during the high speed period in the braking process. The actual acceleration may be measured by one or more in-vehicle sensors and transmitted from the one or more in-vehicle sensors to the comfort brake module 20. For example, referring to FIG. 7, this actual acceleration is expressed as a curve of actual acceleration changing over time.

The “high speed segment” may also be referred to as a high speed period, referring to a period in which the vehicle speed of the vehicle V decreases from the speed at the moment of starting comfort brake to a predetermined speed. This period is a relatively high vehicle speed segment during the comfort braking process. The predetermined vehicle speed may be obtained in advance by using a real vehicle test result and/or through model calculation. For example, as shown in FIG. 7, the “high speed period” is a segment between the moment the vehicle starts braking and a moment T. The comfort brake module 20 may determine the high speed segment by monitoring the actual vehicle speed of the vehicle V. For example, speed deceleration begins after the vehicle makes the brake decision, and the comfort brake module 20 determines the segment between the vehicle speed decreasing to the speed at the moment when the comfort brake moment begins and the vehicle speed decreasing to the predetermined speed as the high speed segment/high speed period. It will be understood that the comfort brake module 20 may also determine the high speed period in other manners, for example, by identifying the first half of the braking process as the high speed period or the first ⅓ of the braking process as the high speed period.

In block 604, the comfort brake module 20 calculates an acceleration difference between the actual acceleration and the expected acceleration. For example, the actual acceleration curve in FIG. 7 is subtracted from the expected acceleration curve to obtain the acceleration difference. The acceleration difference can also be expressed as a curve for time changes (not shown in the graph). It will be understood that the expected acceleration here is also selected to correspond to the expected acceleration during the high speed period, e.g., see FIG. 7, in which an acceleration curve is taken from the start of the comfort brake moment to the moment T to participate in calculation.

In block 606, the comfort brake module 20 assesses the comfort degree based on the calculated acceleration difference to obtain a second assessment result (i.e., an assessment result associated with the acceleration difference). The second assessment result includes: The closer the acceleration difference is to zero, i.e., the closer the actual acceleration to the expected acceleration, the higher the comfort degree, and vice versa, the lower the comfort degree.

Similar to block 406, in block 606, the second assessment result may be expressed in a variety of ways. Two examples representing the second assessment result are presented below.

In an embodiment, the comfort brake module 20 determines whether an absolute value of the acceleration difference is less than a second comfort threshold (i.e., a comfort threshold associated with the acceleration difference). The second assessment is that the comfort is satisfactory when the absolute value of the acceleration difference is determined to be less than the second comfort threshold. The second assessment is that the comfort is not satisfactory when the absolute value of the acceleration difference is determined to be not less than the second comfort threshold. In this embodiment, the second assessment result includes two levels of satisfactory and unsatisfactory.

In another embodiment, the comfort brake module 20 expresses the second assessment result with a score, e.g., a score of 0-100 points for the comfort degree, where 100 points represents the highest comfort degree (e.g., zero absolute value of the difference) and 0 points represent the lowest comfort degree (e.g., the absolute value of the difference exceeds the second comfort threshold). In this embodiment, the comfort brake module 20 may employ an algorithmic model or a machine learning model to give a score of the comfort degree.

It will be understood that the second comfort threshold is obtained according to an actual vehicle test result and/or model calculation and is stored in the comfort brake module 20 in advance.

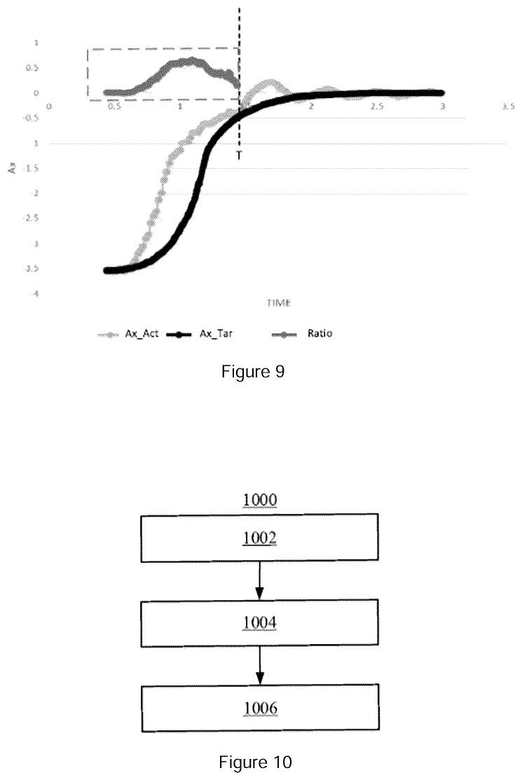

FIG. 8 shows a comfort brake control process 800 according to yet another embodiment of the present disclosure. According to the process 800, the comfort brake module 20 assesses the comfort degree based on a ratio between the above-described acceleration difference and the expected acceleration. FIG. 9 is an example of a curve graph used in the process 800. FIG. 9 is the same as FIG. 8 in the horizontal coordinate, vertical coordinate, black, and light gray curves. FIG. 9 differs from FIG. 8 in that: FIG. 9 adds a dark gray curve (Ratio) surrounded with a dashed box representing the above-mentioned ratio, i.e., the ratio between the acceleration difference and the expected acceleration.

The following describes the process 800 with reference to FIG. 8 and FIG. 9.

In block 802, the comfort brake module 20 calculates the ratio between the above-described acceleration difference and the expected acceleration. For example, referring to FIG. 9, the actual acceleration curve is subtracted from the expected acceleration curve and divided by the expected speed curve to obtain a dark gray curve representing the ratio.

In block 804, the comfort brake module 20 calculates an absolute value of the difference between the ratio and ratio threshold obtained in block 802. The ratio threshold is obtained according to an actual vehicle test result and/or model calculation and is stored in the comfort brake module 20 in advance. The ratio threshold may be a variable, e.g., expressed as a curve changing over time (not shown in the graph).

In block 806, the comfort brake module 20 assesses the comfort degree based on the absolute value of the difference calculated in block 804 to obtain a third assessment result (i.e., an assessment result associated with the ratio). The third assessment result includes: The smaller the absolute value of the difference, the higher the comfort degree; otherwise, the greater the absolute value of the difference, the lower the comfort degree.

Similar to blocks 406 and 606, in block 806, the third assessment result may be expressed in a variety of ways. Two examples representing the assessment result are presented below.

In an embodiment, the comfort brake module 20 determines if the absolute value of the difference is less than a third comfort threshold (i.e., a comfort threshold associated with the ratio). When the absolute value of the difference is determined to be less than the third comfort threshold, the third assessment result is that the comfort is satisfactory. When the absolute value of the difference is determined to be not less than the comfort threshold, the third assessment result is that the comfort is not satisfactory. In this embodiment, the third assessment result includes two levels of satisfactory and unsatisfactory.

In another embodiment, the comfort brake module 20 expresses the comfort degree assessment result with a score, e.g., a score of 0-100 points for the comfort degree, where 100 points represents the highest comfort degree (e.g., zero absolute value of the difference) and 0 points represent the lowest comfort degree (e.g., the absolute value of the difference exceeds the third comfort threshold). In this embodiment, the comfort brake module 20 may employ an algorithmic model or a machine learning model to give a score of the comfort degree.

It will be understood that the third comfort threshold is obtained according to an actual vehicle test result and/or model calculation and is stored in the comfort brake module 20 in advance.

In the above described comfort brake control processes 400, 600, and 800, the comfort degree of vehicle braking after modifying the brake parameter is assessed from different dimensions. According to the process 400, a comfort assessment can be made for the end of the vehicle braking (i.e., the brake period from the vehicle speed dropping to zero to full stop of the vehicle). According to the processes 600 and 800, a comfort assessment can be made for the early stage of vehicle braking (i.e., during high speed period where the vehicle speed is higher during the braking process). In this way, at different stages throughout the braking process, the brake comfort can be assessed in the most appropriate dimensions, and accurate and comprehensive brake comfort assessment results can be obtained.

FIG. 10 shows a comfort brake control process 1000 according to yet another embodiment of the present disclosure. According to the process 1000, the comfort brake module 20 performs comprehensive assessment based on the user experience and the above-described comfort assessment results and provides the comprehensive assessment result to the user.

In block 1002, the human-machine interaction interface 10 receives a user experience score. The user experience score is a score given by the user for the experience of the braking process of the vehicle after modifying the brake parameter. The higher the user experience score, the better the user experience. Conversely, the lower the user experience score, the worse the user experience. The range of user experience scores can be between 0-10, can be between 0-100, or can be expressed in other ranges or forms.

For example, the user modified the brake parameter, then the user experienced the braking process after the brake parameter is modified, and then the user rated his/her experience. The user may enter a given score on the touchscreen, for example, by entering “85 points” in the text box for the user experience score of the graphical user interface on the touchscreen. The user can also use voice to say the given score, for example, the user speaks: “The brake experience score is 85”.

In block 1004, the comfort brake module 20 calculates a comprehensive score based on one or more of received user experience scores and the above described comfort assessment results. The higher the comprehensive score, the higher the degree or probability that this modification will be accepted.

In an embodiment, the comfort brake module 20 calculates the comprehensive score based on the following equation:

F=c*A1+(1−c)*A2
where F is the comprehensive score;
A1 is the user experience score after normalization processing;
A2 is the assessment result of the comfort degree after normalization processing; and
c is a weight coefficient of A1 and 0<c<1.

With respect to parameter A1 in this embodiment, the comfort brake module 20 may normalize the user experience score to obtain a normalized user experience score A1 between 0-1.

With respect to parameter A2 in this embodiment, the comfort brake module 20 may normalize the assessment result of any of the first to third assessment results obtained in the above-described processes 400, 600, and 800 to obtain normalized parameter A2 between 0-1. The comfort brake module 20 may also normalize the first to third assessment results obtained in the above-described processes 400, 600, and 800, respectively, to obtain the calculated average to obtain normalized parameter A2 between 0-1. For example, the results obtained in the processes 400, 600, and 800 are 50, 60, and 80 points, respectively. Then the comfort brake module 20 first normalizes the 50 points, 60 points, and 80 points respectively to obtain: 0.5, 0.6, and 0.8, then calculates the average of 0.6 of 0.5, 0.6, and 0.7, i.e., normalized parameter A2 is obtained as 0.6.

Parameter c in this embodiment may be preset, e.g., pre-determining that the two factors of the user experience score and the comfort degree assessment result are equally important in the comprehensive score, and c may be set to 0.5 in advance. Also, parameter c may be adjusted according to an application scenario or user requirements. For example, a user requiring the vehicle braking process to follow his/her own feelings more may adjust c to a greater value, e.g., 0.8, and accordingly, the weight coefficient (1-c) of parameter A2 is 0.2.

Such a setting is advantageous. By normalizing both the user experience score and the comfort degree assessment result, and assigning weight coefficients to both, both factors can be considered into the comprehensive comfort score at the same time, and the degree of importance of both in determining the comprehensive comfort score can be determined based on the application scenario and user requirements. In this way, the comprehensive comfort assessment, i.e., it includes the subjective feelings of the user, and includes the characteristics of vehicle behavior calculated with the aid of algorithm logic, so as to obtain the comprehensive assessment results of a combination of subjectivity and objectivity, so as to achieve a comfort brake function that is both advanced and humanistic.

In block 1006, the human-machine interaction interface 10 provides the comprehensive score. For example, the comprehensive score is presented on the touchscreen or the comprehensive score is broadcast via voice.

It will be understood that the process 1000 is performed when the modification of the brake parameter satisfies the safety requirement. If the modification of the brake parameter does not satisfy the safety requirement, the modification will not be allowed and the comfort assessment process will not be performed.

In embodiments of the present disclosure, the “user” of the vehicle is capable of modifying the brake parameter of the comfort brake level, e.g., the user may include a person authorized to modify the brake parameter and a creator of the comfort brake system 100. The person authorized to modify the brake parameter includes, for example, an OEM engineer and an operator of a 4S store authorized to modify the brake parameter.

The embodiments of the present disclosure are applicable to a self-driving vehicle or a vehicle that has a self-driving capability. Herein, “the self-driving vehicle” or “the vehicle that has a self-driving capability” refers to a vehicle that is constructed to perform an operation without continuous intervention (for example, steering, accelerating, or braking) from a driver. “Self-driving” may include partial self-driving (for example, self-driving with a safety officer on a self-driving vehicle or with occasional human intervention) and full self-driving (for example, self-driving without a safety officer on a self-driving vehicle or without any human driver intervention). The self-driving capability of the vehicle may be implemented by using an advanced driving assistance system or an autonomous driving system that is disposed on the vehicle.

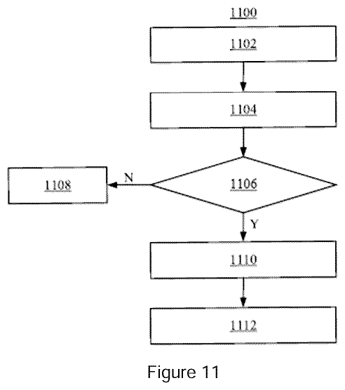

FIG. 11 shows a comfort brake control method 1100 according to an embodiment of the present disclosure. The method 1100 may be implemented by using the foregoing system 100, and therefore the foregoing description about the system 100 is also applicable to this method.

Referring to FIG. 11, in block 1102, the human-machine interaction interface 10 provides an interface for modifying one or more brake parameters.

In block 1104, the human-machine interaction interface 10 receives a modification to at least one of the one or more brake parameters.

In block 1106, the comfort brake module 20 determines whether the modification satisfies the safety requirement.

Upon determining that the result is affirmative, the process 1100 enters block 1110. In block 1110, the comfort brake module 20 allows the modification.

Upon determining that the result is negative, the process 1100 enters block 1108. In block 1108, the comfort brake module 20 prohibits the modification.

In block 1112, the comfort brake module 20 assesses the comfort degree of vehicle braking after the modification when the determining result is affirmative.

Although some implementations are described above, these implementations are provided by way of example only, and are not intended to limit the scope of the present disclosure. The appended claims and their equivalents are intended to cover all modifications, substitutions and changes made within the scope and subject matter of the present disclosure.

What is claimed is:

1. A comfort brake control system for a vehicle having multiple optional comfort brake levels, each comfort brake level comprising one or more brake parameters corresponding to the comfort brake level, the comfort brake control system comprising:
a human-machine interaction interface, configured to provide an interface for modifying the one or more brake parameters and receive a modification to at least one of the one or more brake parameters; and
a comfort brake module, configured to determine whether the modification satisfies a safety requirement, allow the modification when it is determined that the modification satisfies the safety requirement, and prohibit the modification when it is determined that the modification does not satisfy the safety requirement; wherein the comfort brake module is further configured to assess a comfort degree of vehicle braking after the modification if it is determined that the modification satisfies the safety requirement.

2. The comfort brake control system according to claim 1, wherein the one or more brake parameters comprise one or more of: a longitudinal vehicle speed, a longitudinal acceleration, brake pressure of at least one brake cylinder of the vehicle, and a change rate of the brake pressure.

3. The comfort brake control system according to claim 1, wherein the comfort brake module is configured to store a predetermined change range of each brake parameter at each comfort brake level; and
the determining whether the modification satisfies a safety requirement includes:
determining whether the modified at least one brake parameter is within a predetermined change range of a current comfort brake level;
if the determining result is affirmative, determining that the modification satisfies the safety requirement; and
if the determining result is negative, determining that the modification does not satisfy the safety requirement.

4. The comfort brake control system according to claim 1, wherein the assessing the comfort degree comprises:
obtaining a comfort parameter that is capable of characterizing the comfort of the vehicle during a brake period in a braking process of the vehicle;
calculating an absolute value of a difference between a peak value and a valley value of the comfort parameter during the brake period; and
assessing the comfort degree based on the absolute value of the difference to obtain a first assessment result, wherein the first assessment result comprises: the smaller the absolute value of the difference is, the higher the comfort degree is.

5. The comfort brake control system according to claim 4, wherein the comfort parameter comprises one or more of: a longitudinal acceleration of the vehicle, a pitch angle of the vehicle, and a displacement amount of a suspension of the vehicle.

6. The comfort brake control system according to claim 4, wherein the assessing the comfort degree based on the absolute value of the difference comprises:
determining whether the absolute value of the difference is less than a first comfort threshold;
if the determining result is affirmative, the first assessment result is that the comfort is satisfactory; and
if the determining result is negative, the first assessment result is that the comfort is not satisfactory.

7. The comfort brake control system according to claim 1, wherein the comfort brake module stores an expected acceleration in the braking process; and
the assessing the comfort degree comprises:
obtaining an actual acceleration during a high speed period in the braking process, wherein the high speed period refers to a period in which the vehicle speed of the vehicle decreases from a vehicle speed at a moment of starting the comfort brake to a predetermined vehicle speed;
calculating an acceleration difference between the actual acceleration and the expected acceleration; and
assessing the comfort degree based on the acceleration difference to obtain a second assessment result, wherein the second assessment result comprises: the closer the acceleration difference to zero is, the higher the comfort degree is.

8. The comfort brake control system according to claim 7, wherein the assessing the comfort degree based on the acceleration difference comprises:
determining whether the absolute value of the acceleration difference is less than a second comfort threshold;
if the determining result is affirmative, the second assessment result is that the comfort is satisfactory; and
if the determining result is negative, the second assessment result is that the comfort is not satisfactory.

9. The comfort brake control system according to claim 1, wherein the comfort brake module is configured to store an expected acceleration in the braking process; and
the assessing the comfort degree comprises:
obtaining an actual acceleration during a high speed period in the braking process, wherein the high speed period refers to a period in which the vehicle speed of the vehicle decreases from a vehicle speed at a moment of starting the comfort brake to a predetermined vehicle speed;
calculating an acceleration difference between the actual acceleration and the expected acceleration;
calculating a ratio between the acceleration difference and the expected acceleration;
calculating an absolute value of a difference between the ratio and a ratio threshold for the ratio; and
assessing the comfort degree based on the absolute value of the difference to obtain a third assessment result, wherein the third assessment result comprises: the smaller the absolute value of the difference is, the higher the comfort degree is.

10. The comfort brake control system according to claim 9, wherein the assessing the comfort degree based on the absolute value of the difference comprises:
determining whether the absolute value of the difference is less than a third comfort threshold;
if the determining result is affirmative, the third assessment result is that the comfort is satisfactory; and
if the determining result is negative, the third assessment result is that the comfort is not satisfactory.

11. The comfort brake control system according to claim 1, wherein
the human-machine interaction interface is further configured to receive a user experience score given by a user for experience of the vehicle braking process after the modification;
the comfort brake module is further configured to calculate a comprehensive score based on the user experience score and the assessment result of the comfort degree; and
the human-machine interaction interface is further configured to provide the comprehensive score.

12. The comfort brake control system according to claim 11, wherein the calculating a comprehensive score comprises calculating the comprehensive score based on the following formula:
F=c*A1+(1−c)*A2,
wherein F is the comprehensive score;
A1 is the user experience score after normalization processing;
A2 is the assessment result of the comfort degree after normalization processing; and
c is a weight coefficient of A1 and 0<c<1.

13. The comfort brake control system according to claim 1, wherein the comfort brake control system is disposed in the vehicle;
the human-machine interaction interface comprises at least one of: a voice interaction interface, a touchscreen, and a physical key; and
the comfort brake module is disposed in a control unit of the brake system of the vehicle or disposed in a domain controller of the vehicle.

14. A comfort brake control method for a vehicle, wherein the vehicle has multiple optional comfort brake levels, each comfort brake level comprises one or more brake parameters corresponding to the comfort brake level, and the method comprises:
providing an interface for modifying the one or more brake parameters;
receiving a modification to at least one of the one or more brake parameters;
determining whether the modification satisfies the safety requirement;
allowing the modification when it is determined that the modification satisfies the safety requirement; and
prohibiting the modification when it is determined that the modification does not satisfy the safety requirement; and
the method further comprises: assessing a comfort degree of vehicle braking after the modification if it is determined that the modification satisfies the safety requirement.

15. The comfort brake control method of claim 14, wherein the method is performed by the comfort brake control system of claim 1.
